(19) United States
(12) Patent Application Publication
(10) Pub. No.: US 2012/0095780 A1
(43) Pub. Date: Apr. 19, 2012

(54) ASSESSING CONSISTENCY OF A PATIENT'S CONTINUITY-OF-CARE RECORDS

(75) Inventor: DOUGLAS S. McNAIR, LEAWOOD, KS (US)

(73) Assignee: CERNER INNOVATION, INC., OVERLAND PARK, KS (US)

(21) Appl. No.: 13/269,279

(22) Filed: Oct. 7, 2011

Related U.S. Application Data
(60) Provisional application No. 61/391,123, filed on Oct. 8, 2010.

(51) Int. Cl. G06Q 50/24

(52) U.S. Cl. 705/3

(57) ABSTRACT

Methods, systems, and computer storage media are provided for monitoring of the internal consistency and reliability of health information about a patient that is generated by a plurality of respondents and exchanged between more than two users of systems that store and maintain such health information.

### CROSS-REFERENCE TO RELATED APPLICATIONS

This application claims the benefit of priority of U.S. Provisional Application No. 61/391,123, filed Oct. 8, 2010, which is expressly incorporated by reference herein in its entirety.

### BACKGROUND

For the most part, patient health information is still today stored on paper records in a variety of locations. Aside from larger facilities of care, there are few providers of care that have true electronic records and even fewer have the ability to exchange that information. Many providers claiming to have “electronic health records” are actually scanned copies of paper records and those that do have a true electronic medical records (EMR) system rarely adhere to a given format or nomenclatural standard able to support accurate retrieval of records according to their content referencing a particular attribute of the patient.

Subsequently, providers of care rarely have comprehensive patient health information when and where it is needed most, at the current point-of-care wherever care services are being rendered. Current health information exchange initiatives are trying to solve this problem by setting criteria and standards to support interoperability among systems so providers can safely and securely access and retrieve clinical data in order to provide safer and more efficient and equitable patient care.

Two important aspects for broad health records connectivity and interchange are (1) the ability to identify the patient with a master patient index and (2) having clear, standardized, interoperable definitions for health information exchange (HIE) information so that particular relevant items can be searched and retrieved and ‘like’ can be compared to ‘like’ or so that discrepancies can be identified, both within a given patient's records and between different patients' records. The National Alliance for Health Information Technology (http://www.medicalnewstoday.com/articles/160887.php) worked on a consensus definitions report for the Office of the National Coordinator for Health IT (ONC) to help alleviate the problem of definitional and nomenclatural standards. The Alliance released their final report, “Defining Key Health Information Technology Terms”, Apr. 28, 2008, and many current electronic health records systems are currently adopting HL7 RIM or related means of interrelating nomenclature codes that are used in exchanges of information between systems.

As existing electronic Health Information Exchanges (HIEs) mature and others develop, they are determining how best to organize for the development and growth of these exchanges and how they should interact. Thus far, three technical architecture models have emerged:
Federated model (also known as “distributed” or “peer-to-peer”): In this model, each data provider maintains its own health information database and has an interface with every other provider participating in the exchange to share information privately and securely. No one data provider has a complete medical record of a patient.
Centralized model: In this model, all data on a particular patient are stored in a single, centralized repository and providers submit data to the repository. There may be several, community-based centralized repositories in this model, as opposed to one national centralized repository.
Health record data bank: This is the newest model to emerge, where patients “deposit” health information (and pay a fee themselves or through their health insurers) into health record data banks. This model is similar to the centralized model. However, it differs in the sense that it is dependent primarily on patient-submitted data as opposed to provider-submitted data. Providers also may, with the consent of the patient, deposit health information into and access health information of their patients from the health record data bank.

The exchange will focus on integrating patient information and linking providers on an interoperable network to improve patient care and reduce costs by:
1. Decreasing medical errors due to gaps in information between providers and providing a platform for improving chronic care management
2. Decreasing uncertainty among patients and increasing compliance
3. Decreasing duplication of services, which in turn decreases risk to patients and provider costs
4. Provide a central data repository service, which will lead to comprehensive bio-surveillance and syndromic surveillance systems
5. Administer chronic disease registers for chronic conditions such as cancer, diabetes, chronic obstructive pulmonary disease, and heart failure
6. Collaborate with the clinical services to provide support to patients such as recall reminders and maintaining a reporting system for the provider for quality process
7. Support screening and other disease prevention programs
8. Create a portable patient record using swipe cards or jump drives to be used in emergency/disaster situations or improve access to care for routine medical treatment
9. Provide the patient with information about providers
10. Provide the patient with access to his own health records and the opportunity to add self-reported personal health information and to annotate or rebut attributions made by others about his/her health or the nature or outcomes of his/her care episodes
11. Provide healthcare providers with ready internet-based access to all of the information about the patient, regardless where or by whom the information was generated, to know the details of its provenance, and to be able to assess its authenticity and validity.

To date, developments in automating health problem lists have been limited to institution-specific systems with little capacity to share this information with other care providers. This lack of integration requires redundant entry of information by multiple geographically-distributed providers caring for the same patient, and reliance on patients' self-reported drug and disease histories that are known to have poor accuracy due to a variety of factors, including the possibility that the patient may aim to deceive or defraud multiple providers by engaging in a pattern of deception by entries of self-reported false information into the health record or by annotating or obfuscating entries that have been made by others.

Accordingly, there is a broad problem of how to provide (in the context, for instance, of health information exchanges (HIEs) and portable interoperable electronic health records) a mechanism whereby differences of opinion or fact can be automatically identified and the frequency or severity or extent of them disclosed to the affected parties, including the patient and providers and ancillary services (such as pharmacies) who are actively providing care services to the patient or who have been engaged to provide them in the near future. In each category or aspect of the patient's health or health services, it is desirable to have a measure of the internal consistency (or lack thereof) of the multiple attributions that have been made, by various providers that the patient has received services from in the past as well as by the patient or, if applicable, by other family members or guardians who are acting on the patient's behalf. When the concordance or discordance of multiple attributions is identified, then the affected parties can evaluate the evidence and ascertain the authenticity and validity of the various items in the health record.

When using binomial scales or ordinal Likert-type scales, Cronbach's alpha coefficient is able to ascertain the internal consistency and reliability for scales or subscales pertaining to a concept or factor. The analysis of the data then must use these summated scales or subscales and not individual items. If one does otherwise, the reliability of the items is at best probably low and at worst unknown.

Cronbach's alpha only ascertains the consistency and inter-rater reliability of two or more items taken together as a composite scale ore measure and does not provide reliability estimates for single items. For single items, the Mann-Whitney-Wilcoxon test or Kruskal-Wallis ANOVA or other nonparametric statistical tests may be used. However, it is unlikely in the course of routine care that one would accumulate a statistically adequate sample size comprised of a multiplicity of observations of the same attribute at the same time-coordinate to provide adequate statistical power for reliable acceptance of the null hypothesis of ‘no difference.’

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A system, method and computer-readable media are provided for ad hoc and periodic monitoring of the internal consistency and reliability of health information about a patient that is generated by a plurality of respondents and exchanged between more than two users of systems that store and maintain such health information. In embodiments, the application of Cronbach alpha coefficients assist in determining presence or not of significant inconsistency or disagreement among a plurality of attributions about a particular patient that are made by three or more respondents whose attributions regarding the patient are stored in and retrievable from, for instance, an EMR or HIE system.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention; and

FIGS. 2A and 2B represent a flow diagram illustrating an exemplary process for ascertaining the presence of significant disagreement amongst multiple records that pertain to the same concepts or items for the same patient, as ascribed by multiple individuals.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention relate to ascertaining the presence of significant disagreement amongst multiple records that pertain to the same concepts or items for the same patient, as ascribed by multiple individuals.

Reliability of the measures derived from tests and questionnaires refers to the consistency, stability, and repeatability of a data collection instrument. A reliable instrument will have consistent results if repeated overtime or if used by two different investigators. The reliability of an instrument and the validity of the same are different issues. Internal consistency of reliability refers to the extent to which all parts of the measurement technique are measuring the same concept. For example, when developing a questionnaire to measure implicit cognition, each question should provide a measure of implicit cognition consistent with the overall results of the test. Although multiple tests are required for estimating stability and equivalence of reliability, only a single test is needed for estimating internal consistency. Cronbach's alpha coefficient is a widely used index to estimate the internal consistency reliability of a scale containing multiple items.

It is desirable that the estimation of reliability and internal consistency be as accurate as possible, with as few false-positive and false-negative occurrences as possible. In some situations, the standard equation over-estimates or under-estimates the true reliability. Theoretically, when the items of a composite measure are congeneric, or tau-equivalent, the standardized Cronbach alpha will always exceed the true reliability. However, if the measure contains a small number of heterogeneous items, the standardized Cronbach's a tends to under-estimate the true reliability of a measure. And if the items of a scale are characterized by multiple moderately correlated factors, the standardized Cronbach's coefficient α may be under-estimated as well. In practice, the standardized Cronbach's alpha frequently under-estimates the true reliability.

The underestimation of Cronbach's α is more serious when the items are dichotomous, because correlations among dichotomous items (phi coefficients) tend to underestimate true correlations. This present invention ameliorates the underestimation of standardized Cronbach's α by employing the upper bound of the phi coefficient into the calculation of Cronbach's α.

Lack of reliability is a serious drawback of an outcome measure as it indicates errors in measurements. Inconsistent outcome measures might result in invalid assessments which will consequently lead professionals to making the wrong decisions for their clients.

The number of items included in an outcome measure is implicated in the interpretation of internal consistency estimates. It has been shown that Cronbach's alpha estimation of reliability increases with scale length (i.e. number of items in the scale). The effect on alpha is particularly noticeable when the number of items is below seven.

The width of a scale is another factor which influences the interpretation of reliability estimates, including Cronbach alpha estimates. By inspecting the aggregated possible scoring for each subtest and the number of items this includes, it seems that for “spatial perception”, “orientation”, “praxis”, “visuomotor construction”, and “thinking operations” the possible score range was 1 to 2, 0 to 2, 0 to 2, 1 to 5, and 1 to 5, respectively. Thus, the width of the scale for “orientation” (for which alpha was below 0.7) was quite limited (3-point scale). It has been known that wider scales tend to have greater variance than scales of lesser width, and this greater variance tends in turn to increase alpha values. In the psychological research literature, this phenomenon has been found to happen in scales with over 4-points' width. In the Voss study, the small width scale (3-points) might be one possible explanation for the low alpha estimate of the “orientation” subtest.

The sample size may also influence reliability estimates. Measurements involving small numbers of respondents may be vulnerable to erroneous over-estimates of reliability as well as to spurious under-estimation of reliability. This vulnerability can be mitigated to a degree by increasing the number of items that are included in the scale or subscale being measured.

In embodiments, the present invention utilizes a plurality of coded, standardized items for each scale or subscale to enable ascertainment of internal consistency or reliability via Cronbach alpha metrics with as few as three respondents or systems providing responses for each of the items comprising the scale or subscale. In the illustrative embodiment, the scale or subscale is comprised of at least eight items.

In the instance of binomial and ordinal item variables, the codes or textstring descriptors of the variables' values are converted directly to integer values. In the instance of a continuous or floating-point decimal or interval variable, the numeric value of the variables' values are used as-received, without change. To insure that none of such items is unduly given more weight than other items and, conversely, to insure that none of the items is wrongly accorded less weight than it merits, in an embodiment, a preprocessing step to standardize each item variable is performed, so that each transformed item has a mean equal to zero and a standard deviation equal to one.

In the instance where the item is a categorical variable whose original, as-received values are not organized in an ordinal or numeric fashion, the codes or textstring descriptors of the variables' values are assigned to integer values that are sustained throughout the current consistency-checking session but are not otherwise persistent beyond the scope of the current consistency-checking session. After the integer-assignment “mapping” step, the standardization pre-processing step is performed as described above.

In the instance where an item response is missing or a respondent neglected to account for the item by providing a response, the value for that item-nonresponse for that respondent shall be substituted by a special, system-reserved value denoting “not available” or “not-a-number”, so as to be distinguishable from items for which positive responses have been explicitly recorded. In this manner, the statistical method for processing the values for the various respondents' attributions for variables included in the scale or subscale will be able to correctly recognize the item as missing or null and calculate the Cronbach alpha coefficients appropriately.

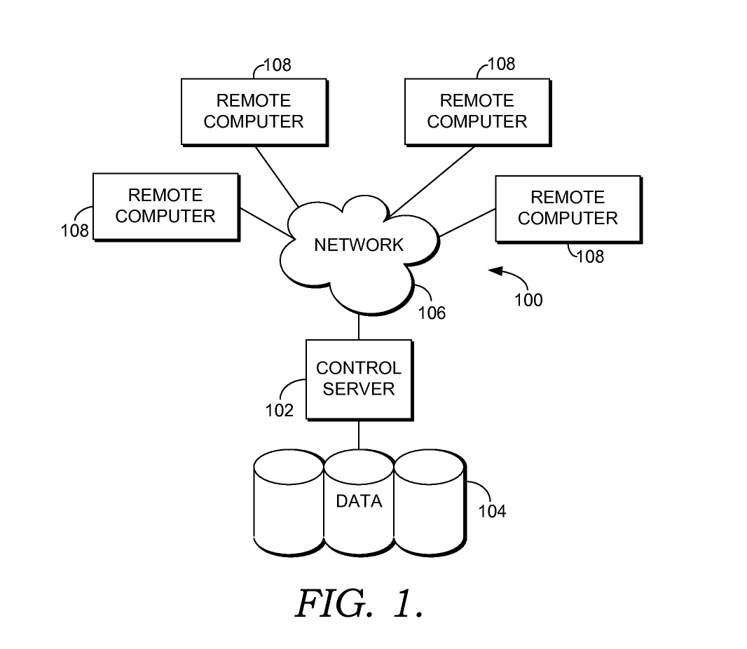

Cronbach alpha coefficients and the Cronbach Mesbah curve may be calculated, in an illustrative embodiment, via a cloud-based service running an instance of the R statistical software with the CMC package. As will be further described herein, FIG. 1 shows an exemplary computing system environment 100 in which the aforementioned cloud-based services may operate. A numerical array X(i,j) consisting of j=2, . . . , K items (columns) comprising the scale or subscale of interest sourced by each of the i=3, . . . , N respondents (rows) is passed to the alpha.cronbach(X) and alpha.curve(X) functions in R, and the output of those functions is returned to the calling server process.

If the Mesbah curve slope is non-negative-valued for some value of j>3 and Cronbach alpha >0.70 for some value of j>2, then the process quiesces with insufficient evidence of inconsistency or discrepant attributions regarding the scale to which the items pertain, for the particular date-time coordinate at issue.

By contrast, if the Mesbah curve slope is negative-valued or if Cronbach alpha <0.70 for all relevant values of j, then sufficient evidence of internal inconsistency among the items does exist, and an alert disclosing this is emitted to the client application for display to the user. In other embodiments, the alert may be deposited in the electronic health record in a suitable location or, for instance, conveyed to another appropriate persistent storage medium for subsequent use for quality and safety review, risk management reporting, health services and public health research, or for other purposes.

In some situations, apparent discrepancies may merely reflect the transience or intermittency of a symptom. In other situations, discrepancies may denote deep, irreconcilable disputes about what was done or by whom it was done, what event happened to the patient and where it occurred, what side-effect or adverse event materialized, how severe or disabling a condition is, when a disease or condition began or its temporal relationship to a putative cause or risk factor, or other matter.

To be able to automatically detect concordance or discordance in this manner, it is necessary either to have standardized nomenclatures and discrete codes in the health records themselves or to programmatically infer such standardized codes and labels by natural language processing methods. To date, many EMR and HIE systems are utilizing HL7's Reference Information Model (RIM) standard, with SNOMED-CT and UMLS and related nomenclatural standards and cross-walk tables.

The purpose of a Reference Information Model (RIM) is to share consistent meaning beyond a local context. In general, the broader the scope of interest, the more important it is to make all assumptions about a topic of interest explicit. The HL7 Version 3 Reference Information Model (RIM) is a comprehensive source of all information subjects used in any HL7 specification. Since HL7 specifications permit loosely coupled information systems to interoperate, the scope of the HL7 RIM is the information required to be understood between interoperable information systems, but not necessarily all information recorded within any particular system. As HL7 specifications are used to connect information systems operated in different circumstances, across many types of healthcare delivery organizations and potentially across political jurisdictions, a RIM needs to be flexible enough to express a diverse range of information content while maintaining a unified framework.

The HL7 RIM articulates explicit definitions of the things of interest referenced in HL7 messages, structured documents or any future HL7 “information packages” specification. The RIM also contains definitions of the characteristics of these things of interest and the relationships among them.

HL7's Information Exchange Requirements (IERs) standards establish specifications for exchanges of health information between systems. For example, IER40 specifies a query by one system or application, to retrieve existing health data from another system; IEF42 specifies a request by one system or application to receive medical concept information from another system.

Accordingly, in connection with the as-yet unmet interoperability-related needs noted above, embodiments of the present invention apply Cronbach alpha coefficients for the purpose of ascertaining the presence or not of significant inconsistency or disagreement among a plurality of attributions about a particular patient. It should be noted that when items are not strictly parallel, the Cronbach's alpha coefficient provides a lower bound estimate of true reliability. This estimate may be further biased downward when items are dichotomous. The estimation of standardized Cronbach's alpha for a scale with dichotomous items can be improved by using the upper bound of coefficient phi.

The Cronbach alpha-max curve is constructed by determining for each variable-count K the maximum value of the Cronbach alpha coefficient associated with consecutively adding variables to the scale one at a time. If the slope of the curve is non-negative valued, then the multiple variables comprising the scale or subscale are substantially denoting the same, internally consistent attribute about the patient. If, however, the slope is negative and significantly different from zero, then one or more of the multiple variables in the scale or subscale manifests substantial discrepancies among the multiple respondents whose attributions have been registered, and the collection of records pertaining to that scale or subscale is likely to be inconsistent or unreliable and merits further examination by and/or dialogue amongst the affected parties before the inconsistent information contained therein is relied upon for health care decision-making.

Having briefly described embodiments of the present invention, an exemplary operating environment suitable for use in implementing embodiments of the present invention is described below. Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network.

Remote computers 116 may be located at a variety of locations in a medical or research environment, for example, but not limited to, clinical laboratories, hospitals and other inpatient settings, veterinary environments, ambulatory settings, medical billing and financial offices, hospital administration settings, home healthcare environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 116 may also be physically located in nontraditional medical care environments so that the entire healthcare community may be capable of integration on the network. The remote computers 116 may be personal computers, servers, routers, network PCs, peer devices, other common network nodes, or the like, and may include some or all of the components described above in relation to the server 110. The devices can be personal digital assistants, mobile phones, tablet computers, or other like devices.

Exemplary computer networks 114 may include, without limitation, local area networks (LANs) and/or wide area networks (WANs). Such networking environments are commonplace in offices, enterprise-wide computer networks, intranets, and the Internet. When utilized in a WAN networking environment, the server 110 may include a modem or other means for establishing communications over the WAN, such as the Internet. In a networked environment, program modules or portions thereof may be stored in the server 110, in the database cluster 112, or on any of the remote computers 116. For example, and not by way of limitation, various application programs may reside on the memory associated with any one or more of the remote computers 116. It will be appreciated by those of ordinary skill in the art that the network connections shown are exemplary and other means of establishing a communications link between the computers (e.g., server 110 and remote computers 116) may be utilized.

In operation, a user may enter commands and information into the server 110 or convey the commands and information to the server 110 via one or more of the remote computers 116 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 110. In addition to a monitor, the server 110 and/or remote computers 116 may include other peripheral output devices, such as speakers and a printer.

Although many other internal components of the server 110 and the remote computers 116 are not shown, those of ordinary skill in the art will appreciate that such components and their interconnection are well known. Accordingly, additional details concerning the internal construction of the server 110 and the remote computers 116 are not further disclosed herein.

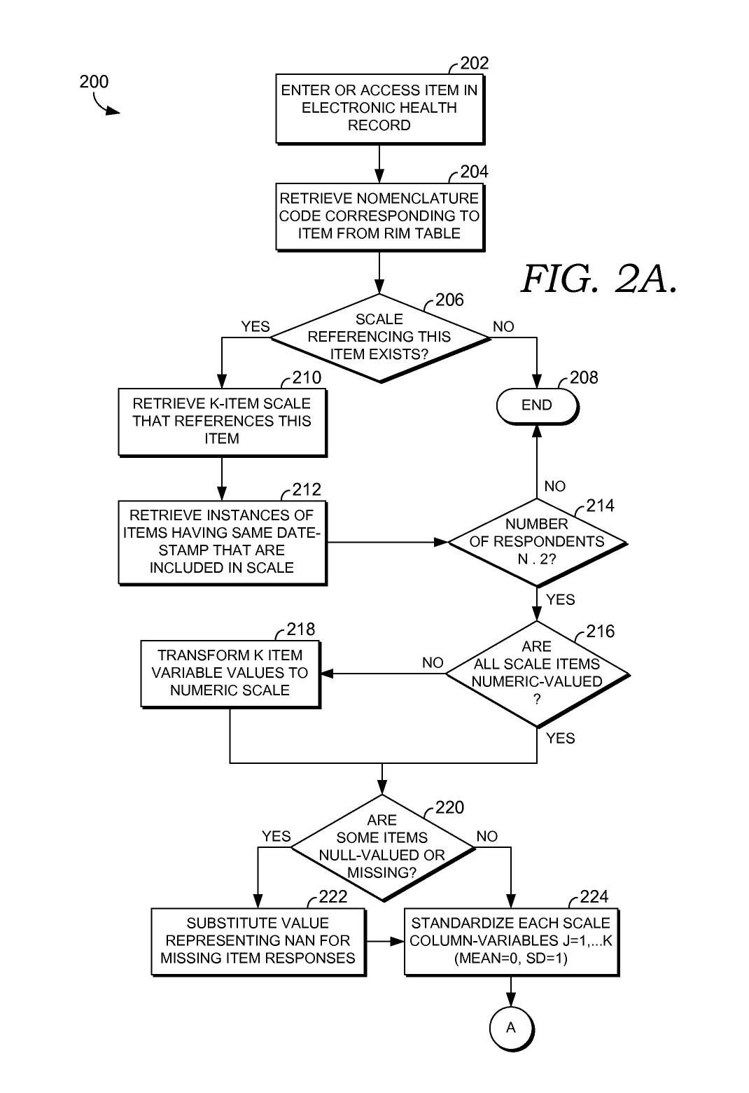

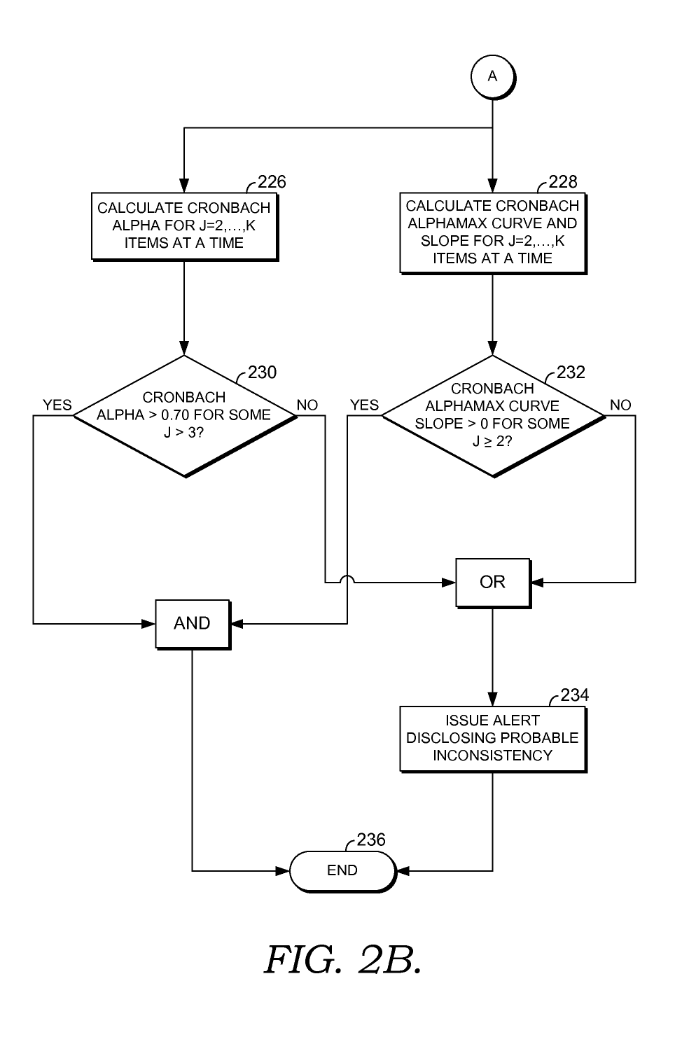

Turning now to FIGS. 2A and 2B, a flow diagram illustrates an exemplary process for ascertaining the presence of significant disagreement amongst multiple records that pertain to the same concepts or items for the same patient, as ascribed by multiple individuals.

At step 202, an electronic health record of an individual is entered or accessed. Thereafter, a nomenclature code, for instance, corresponding to an item from, for instance, HL7's Reference Information Model (RIM) standard table, at step 204. A determination is then made at step 206 whether a scale referencing the particular health item or concept about the patient exists. If the aforementioned scale does not exist, then the process 200 ends at step 208 without issuing an alert or other message regarding a probably inconsistency. Otherwise, if the scale does exist, then at step 210, a k-item scale that references the particular health item is retrieved and then at step 212, instances of health items having the same date-stamp that are included in the scale are retrieved.

At step 214, it is determined whether the number of respondents that have provided the particular health items or concepts for this patient are greater than two. If not, then the process ends at step 208; otherwise, if the respondents do number greater than two, a determination is made at step 216 as to whether all scale items are numeric valued. If all scale items are not numeric valued, then at step 218, k item variable values are transformed to numeric scale and the process continues at step 220; otherwise, if the scale items are all numeric valued, then the process moves directly to step 220.

A determination is made at step 220 whether some items are null-valued or missing. If some items are in fact null-valued or missing, then at step 222, a value representing NaN for missing item responses is substituted and the process continues at step 224; otherwise, if no items are null-valued or missing, then the process moves directly to step 224. Each scale column-variables J=1, . . . K (mean=0, standard deviation=1) is then standardize, at step 224. Thereafter, at step 226 cronbach alpha for J=2, . . . , K items at a time is calculated, and at step 228, cronbach alphamax curve and slope for J=2, . . . , K items at a time is calculated. It is determined, in step 230, whether cronbach alpha is greater than 0.7 for some J greater than three. It is also determined, in step 232, whether cronbach alphamax curve slope is greater than zero for some J greater than or equal to two. If it is determined that cronbach alpha is greater than 0.7 for some J greater than three and also determined that cronbach alphamax curve slope is greater than zero for some J greater than or equal to two, then the process 200 ends at step 236 without issuing an alert or other message regarding a probably inconsistency. Otherwise, if it is determined that either (a) it is not found that cronbach alpha is greater than 0.7 for some J greater than three, or (B) it is not found that cronbach alphamax curve slope is greater than zero for some J greater than or equal to two, then from steps 230 and 232, it follow that at step 234, an alert or other message is issued that discloses the probable inconsistency, so that health providers (e.g., nurses, doctors) or other interested parties (e.g., clinical researchers) can take the necessary steps to provide proper care for the particular patient. For instance, a real-time automatic alert message is communicated to the user when a particular item has been newly entered by that user or a particular item pertinent to the user's current review or transacting against the electronic health record for a patient may result in the access and retrieval of other conceptually interrelated items concerning one or more scales or subscales, from a plurality of respondents and possibly from a plurality of geographically distributed health systems, such that the Cronbach alpha and alpha-max metrics for the multi-item scale or subscale indicate significant disagreement and departure from internal consistency.

### Computation of Cronbach Alpha Statistics

For example, an XML health information exchange item pertaining to the surgeon's operative note for a patient may represent the following:

<component>

<section>

<templateId root=“2.16.840.1.113883.10.20.7.7”/>
<code code=“10221-0” codeSystem=“2.16.840.1.113883.6.1”
codeSystemName=“LOINC” displayName=“OPERATIVE NOTE SPECIMENS

REMOVED”/>

<title>Specimens Removed</title>
<text>

<list>

<item>Vas deferens</item>

</list>

</text>
<entry>

<procedure classCode=“PROC” moodCode=“EVN”>

<id root=“d68b7e32-7810-4f5b-9cc2-acd54b0fd86d”/>
<code code=“80146002” codeSystem=“2.16.840.1.113883.6.96”

displayName=“Vasectomy”/>

<specimen typeCode=“SPC”>

<specimenRole classCode=“SPEC”>
<id root=“c2ee9ee9-ae31-4628-a919-fec1cbb58683”/>

<specimenPlayingEntity>

<code code=“421615004” codeSystem=“2.16.840.1.113883.6.96”
displayName=“Vas deferens segments, right and left”/>

</specimenPlayingEntity>

</specimenRole>

</specimen>

</procedure>

</entry>

</section>

</component>

However, the microscopic examination by the surgical pathologist may find that the tissue submitted was in fact fibrous connective tissue and not vas deferens at all. The patient may later annotate one or both of those items attesting that he has now become a father of a child conceived subsequent to the putative vasectomy. Or another provider may later submit a new accession into the patient's health record whose code denotes “SPERM COUNT” with a non-zero test result value for viable sperm identified in the specimen.

While a competent human being could review such records an readily determine that the operative note indicating that the vasectomy was successfully completed is discrepant with self-reported observations and laboratory reports indicating the patient's persistent fertility which proves that the vasectomy was in fact not completed successfully, it is not possible for a computer system to determine this unless there are (1) nomenclatural code means to coherently refer to the same concept interoperably and retrieve from possibly a plurality of sources the extant records for this patient pertaining to this concept, and (2) an consistency-checking system and method to measure the internal consistency and reliability of those records and to disclose the discrepancy among them.

The present invention utilizes Cronbach alpha and Cronbach-Mesbah curve calculations to provide consistency-checking and inconsistency-detection capabilities directed to the latter of these two aspects. In the illustrative embodiment, the system and method may be applied to electronic health record data concerning scales and subscales related to pain assessment, mental status assessment, cognition assessment, performance status assessment, and anxiety assessment, as examples. However, as will be readily appreciated by those practiced in the art the same system and method may be applied to any set of j=2, . . . , K items that exhibit interrelationships that constitute a scale or subscale pertaining to a particular concept or attribute regarding the person to whom the ascribed variables' values pertain.

Indeed, ad hoc scales can be constructed consisting of just those variables about which the patient or family members have posted self-reported entries and about which at least two other respondents have recorded entries pertaining to that patient. In such instances, the ad hoc scale may be said to denote “patient-provider concordance” (or lack thereof) with regard to that set of variables and their values. If the Cronbach alpha and Cronbach Mesbah curve slope indicate an absence of consistency, that fact may be taken as evidence of substantial disagreement or dispute between the patient and the two or more other respondents. In such a case, the provider respondents and/or quality officers for the health care organizations for whom the providers are acting as agents may need to review and attempt to reconcile or resolve the apparent disagreements or disputed items.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when executed by one or more computing devices, cause the one or more computing devices to perform a method for determining internal consistency and reliability of health information about a patient that is generated by a plurality of respondents and exchanged between two or more users of systems that store and maintain such health information, the method comprising:
receiving patient-specific data from a plurality of different sources;
transforming the data from the plurality of different sources to a numeric scale;
utilizing the transformed data to compute cronbach alpha values and cronbach alpha-max curves for one or more scales or subscales;
determine internal consistency of information that is the subject of one or more scales or subscales based on the computed values for cronbach alpha and cronbach alpha-max curves computed; and
selectively displaying information regarding the determined internal consistency.
